(19) United States
(12) Patent Application Publication
(10) Pub. No.: US 2024/0021359 A1
(43) Pub. Date: Jan. 18, 2024

(54) COIL, PROCESS FOR MANUFACTURING A COIL, AND ASSEMBLY

(71) Applicant: Würth Elektronik eiSos GmbH & Co. KG, Waldenburg (DE)

(72) Inventors: Alexander Gerfer, Odenthal (DE); Dorian Degen, Satteldorf (DE); Marcel Dorr, Ludwigsburg (DE)

(21) Appl. No.: 18/257,081

(22) PCT Filed: Dec. 2, 2021
(86) PCT No.: PCT/EP2021/084036

§ 371 Date: Jun. 12, 2023

(30) Foreign Application Priority Data
Dec. 11, 2020 (EP) 10 2020 215 704.9

(51) Int. Cl. H01F 27/30; H01F 17/04; H01F 27/36; H01F 41/06

(52) U.S. Cl. CPC H01F 27/306; H01F 17/04; H01F 27/366; H01F 41/06; H01F 27/292

(57) ABSTRACT

The invention relates to a coil having an electrically conductive winding, wherein the winding has a first winding connection and a second winding connection, and having a magnetic core, in which the winding extends up to a maximum angle of 290°, in particular 270°, around the core, and the winding is fixed to the core.

The invention relates to a coil having an electrically conductive winding, wherein the winding has a first winding connection and a second winding connection, and having a magnetic core. The invention also relates to a method for producing a coil. The invention further relates to an arrangement having a printed circuit board and a coil.

International patent publication WO 2018/102578 A1 discloses a transformer which has a high current winding and a low current winding. The high current winding has a plurality of half turns, which are connected in parallel. The low current winding has a plurality of complete turns, which are connected in series.

The invention is intended to improve a coil, a method for producing a coil and an arrangement.

According to the invention, for this purpose a coil having the features of claim 1, a method for producing a coil having the features of claim 14 and an arrangement having the features of claim 24 are provided. Advantageous developments of the invention are specified in the sub-claims.

In a coil having an electrically conductive winding, the winding has a first winding connection and a second winding connection. The coil is provided with a magnetic core. The winding extends up to a maximum angle of 290°, in particular 270°, around the core. The winding is fixed to the core.

By means of a winding which extends up to a maximum angle of 290°, a very low inductance of the coil can be implemented. At the same time, such a coil has a very low DC resistance and a very low AC impedance. With an appropriate material selection for the core, a very high saturation current can also be achieved. The coil can consist of soft magnetic material, for example metal or ferrite. Fixing the winding to the core makes handling the coil and in particular its automatic production and its automatic mounting in a circuit considerably easier.

In a development of the invention, the winding extends at least by an angle of 160°, in particular 180°, around the core.

The winding therefore extends around the core by an angle between 160° and 290°. As a result, very low values for the inductance can be achieved.

In a development of the invention, two windings are provided, wherein each winding has a first winding connection and a second winding connection, and wherein each winding extends around the core at least by an angle of 160° and at most by an angle of 290°.

For example, two windings which each extend around the core by somewhat less than 180° are applied to one and the same core. As a result, two windings are arranged in a space-saving way. If necessary, the two windings can also be connected together in order to provide an approximately complete turn.

In a development of the invention, the winding is at least partly formed of metal sheet or of a metal wire with a square or rectangular cross section.

In this way, a very low DC resistance of the coil can be achieved. For example, the winding is formed from copper, silver or aluminium. These metals can be processed very easily and permit a low DC resistance.

In a development of the invention, the winding has at least one first latching element and the core has at least one second latching element, wherein, in the mounted state of the winding on the core, the at least one latching element of the winding interacts with the at least one second latching element of the core in order to hold the winding on the core.

In conventional coils with at least one complete turn, it is not a problem to hold the winding on the core, since the winding certainly encloses the coil at least once. If the winding is designed with an angle of 290° or less, latching elements on the winding and the core permit the winding to be fixed securely to the core. This makes the production and also the handling of the coil considerably easier.

In a development of the invention, the at least one first latching element is formed as a protrusion on the winding which projects in the direction of the core, and the at least one second latching element on the core is formed as a recess or step in the core, wherein the recess or step in the core is designed to match the protrusion on the winding.

By means of a protrusion on the winding and a step or a recess on the core, the winding can be fixed to the core in a very simple manner.

In a development of the invention, a shielding ring of ferrite or an electrically nonconductive metal alloy is provided, which at least partly surrounds the core and the winding.

Such a shielding ring not only shields electromagnetic waves which are produced by the winding during high frequency operation, but can also provide an important contribution to fixing the winding to the core.

For example, the shielding ring is bonded to the core by means of adhesive. As a result, the winding can be held reliably between the shielding ring and the core. The adhesive advantageously has ferrite particles or particles of an electrically nonconductive metal alloy. In this way, the adhesive can also contribute to a shielding action.

In a development of the invention, the core is provided with a groove running around the core by at least 160°, wherein the winding is partially inserted into the groove.

The winding can be fixed simply and securely in a groove on the core. For example, the winding is formed from wire with a rectangular or square cross section. As a result, the wire can be fixed securely to the core by means of simple insertion into a likewise rectangular or square groove.

In a development of the invention, the winding is latched into the groove, pressed into the groove and/or bonded into the groove.

In a development of the invention, the core is provided with at least one circumferential protrusion, the winding engaging partially around the protrusion.

A circumferential protrusion is generally provided in cores of coils in order to hold a conventional winding on the core. This is because one or two circumferential protrusions prevent a winding from slipping off the core in the direction of the central longitudinal axis of the core. In the coil according to the invention, the winding extends up to a maximum angle of 290° around the core. Given such a winding, the circumferential protrusion can be used to hold the winding on the core in that the winding is partly connected to the protrusion.

Advantageously, a section of the winding is pressed onto the protrusion.

The winding consists of metal and can be laid around the protrusion, preferably parallel to the central longitudinal axis of the core. If this section of the winding is then pressed onto the protrusion, the winding is automatically held on the core. For example, a first section of the winding at the start of the winding and a second section at the end of the winding can be pressed with the circumferential protrusion in order to hold the winding securely on the core.

In a method for producing a coil according to the invention, the steps of arranging the at least one winding on the core and of fixing the winding to the core are provided.

Advantageously, the winding, in the mounted state, extends by more than 180° and a maximum of 290° around the core, wherein the steps of bending the winding up, of pushing the winding onto the core and of bending back or springing back the winding are provided, so that the winding rests partly on a circumference of the core.

If the winding extends by more than 180° around the core, the winding can form an undercut after being pushed on and bent back or sprung back. As a result, the winding is held reliably on the core. For example, the winding can simply be pushed onto the core at right angles to the central longitudinal axis of the core. As it is pushed on, the winding then bends up and springs automatically back when the winding is arranged in the correct position on the core.

In a development of the invention, the winding has at least one first latching element and the core has at least one second latching element, wherein the pushing of the winding onto the core and the latching of the first latching element into the second latching element are provided.

When the winding is pushed onto the core, the latching elements can be arranged and formed in such a way that they automatically snap into each other. As a result, fully automatic production of the coil can be made considerably easier.

In a development of the invention, the bonding of the winding and of the core is provided.

The bonding of the winding and core can likewise ensure secure fixing of the winding on the core.

In a development of the invention, pushing a shielding ring onto the core is provided, wherein the winding is arranged at least partly between the shielding ring and the core.

In a development of the invention, the bonding of the shielding ring to the core and/or the winding is provided.

In a development of the invention, the core has at least one circumferential protrusion and the pressing of at least one section of the winding onto the protrusion is provided.

In a development of the invention, the pressing of a first section and a second section of the winding onto the protrusion is provided, wherein the first section and the second section extend parallel to a central longitudinal axis of the core.

The first and the second section then each lead to a connection area for the coil, wherein the connection areas are then arranged either on an underside of the core or adjacent to the underside of the core. The core is advantageously formed rotationally symmetrically about the central longitudinal axis.

In a development of the invention, the rolling of the winding from copper is provided.

In a development of the invention, the punching of the winding from copper sheet is provided.

In an arrangement according to the invention having a printed circuit board and a coil, the first winding connection and the second winding connection are formed as connection pads and soldered to connection areas of a printed circuit board.

The coil then is designed as an SMD component (surface mounted device) and can be placed in a simple way on connection areas of a printed circuit board and then soldered to the latter. This facilitates the fully automatic mounting of the coil according to the invention in a circuit on a printed circuit board.

Further features and advantages of the invention emerge from the claims and the following description of preferred embodiments of the invention in conjunction with the drawings. Individual features of the different embodiments shown and described can be combined with one another as desired without departing from the scope of the invention. This also applies to the combination of individual features without further individual features in connection with which they are shown or described. In the drawings:

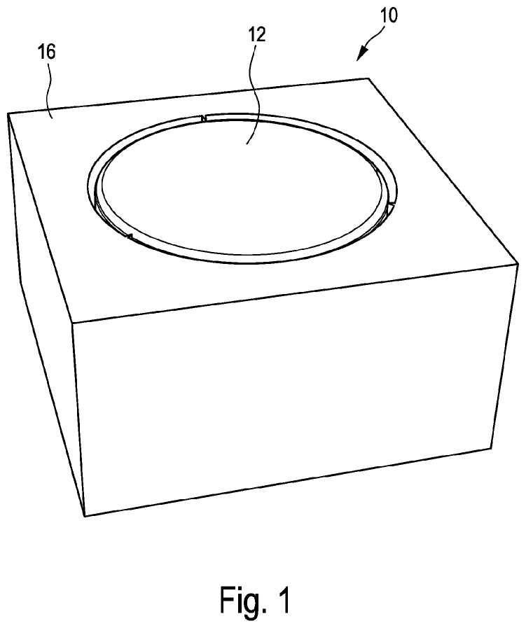

FIG. 1 shows a coil according to the invention according to a first embodiment obliquely from above,

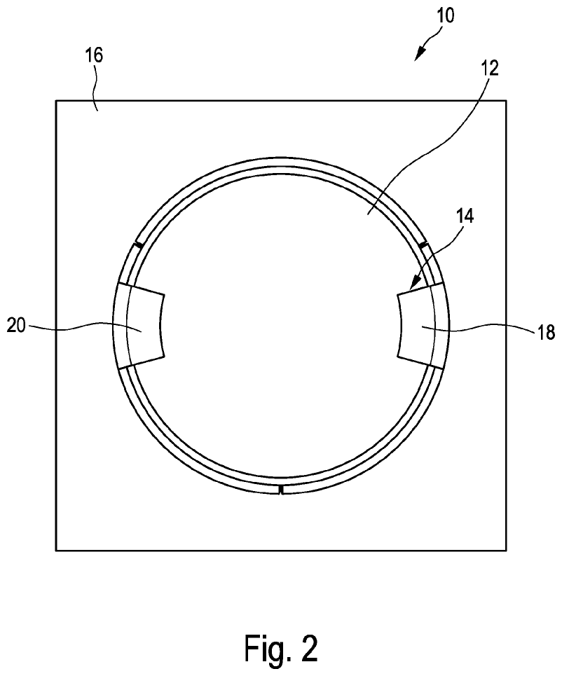

FIG. 2 shows the coil from FIG. 1 from below,

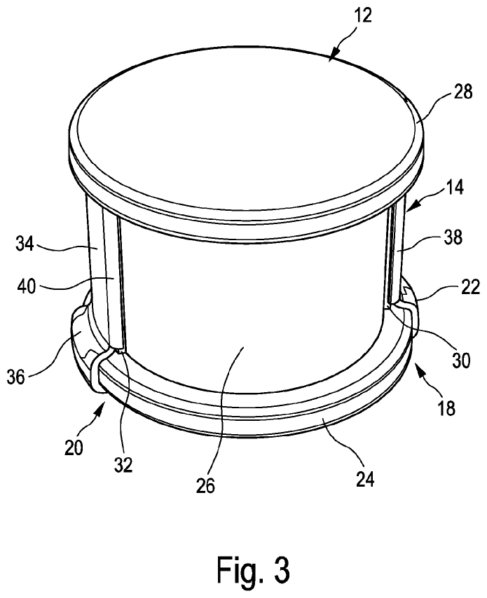

FIG. 3 shows the core and the winding of the coil from FIG. 1 obliquely from above, without the shielding ring,

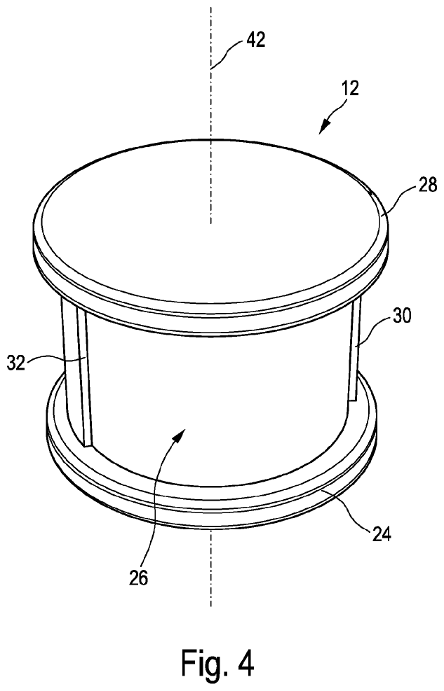

FIG. 4 shows the core of the coil from FIG. 1,

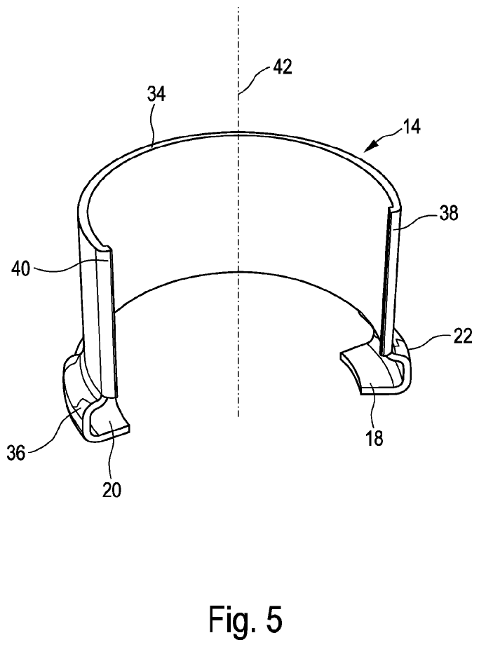

FIG. 5 shows the winding of the coil from FIG. 1,

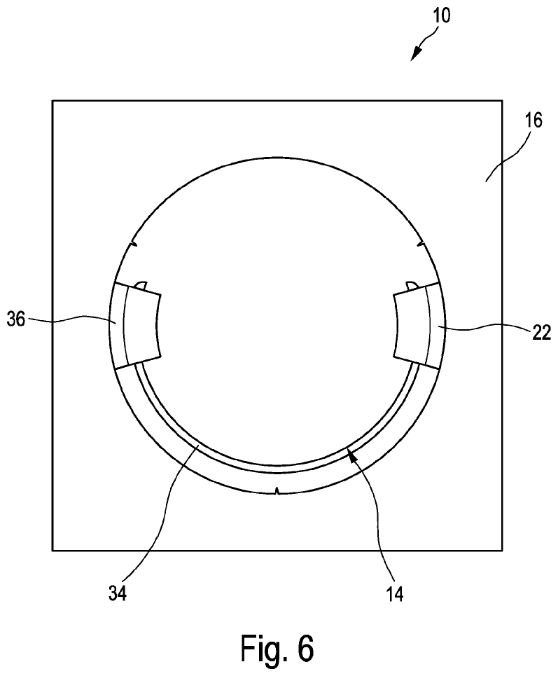

FIG. 6 shows the coil from FIG. 1 from below, the core being hidden,

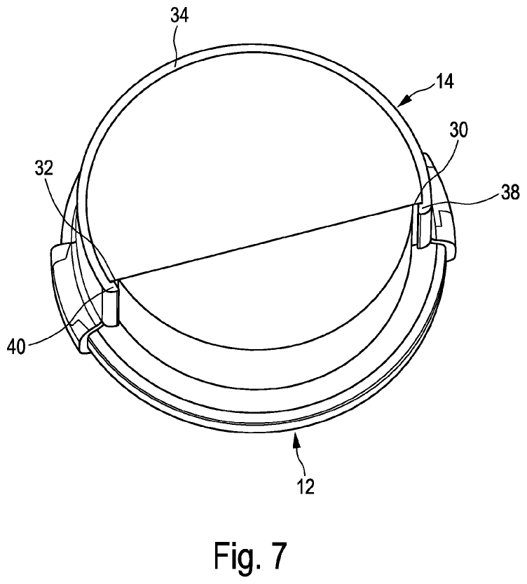

FIG. 7 shows a sectional view of the core with the winding of the coil from FIG. 1 arranged thereon obliquely from above,

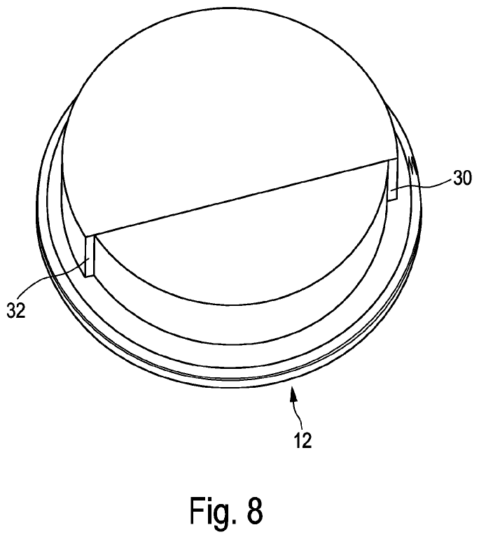

FIG. 8 shows the sectioned core from FIG. 7,

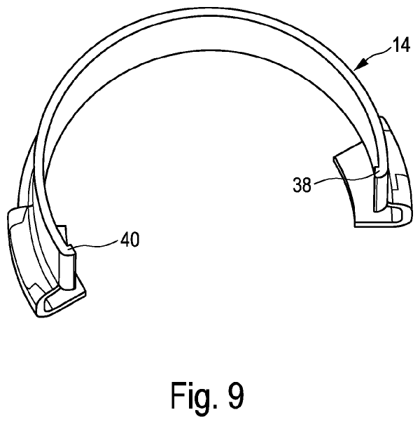

FIG. 9 shows the sectioned winding from FIG. 7,

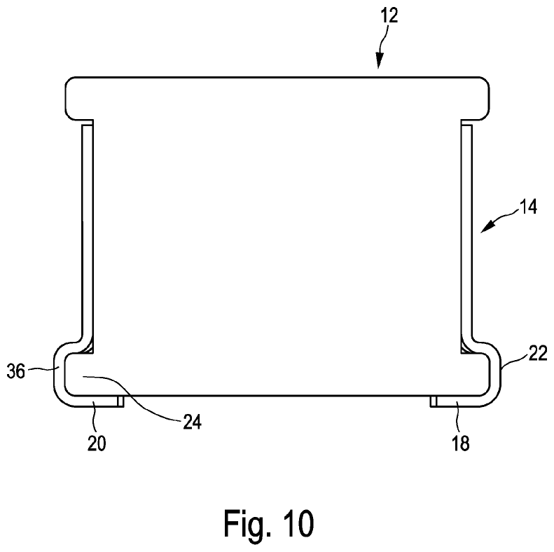

FIG. 10 shows a further sectional view of the core with the winding arranged thereon,

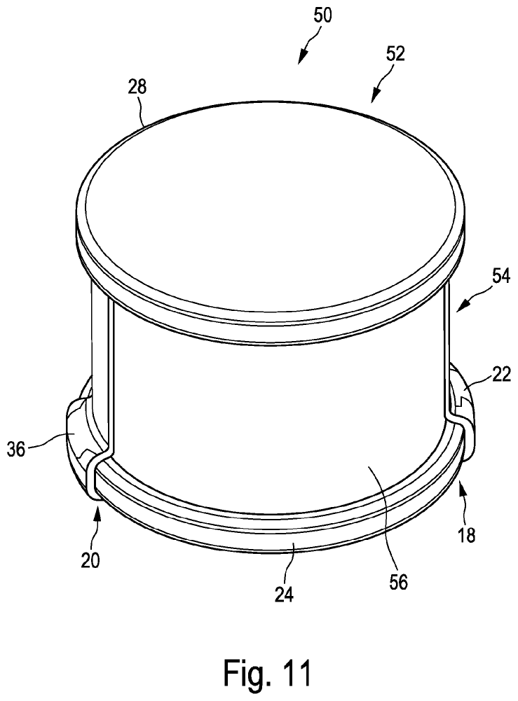

FIG. 11 shows a coil according to the invention according to a second embodiment of the invention obliquely from above,

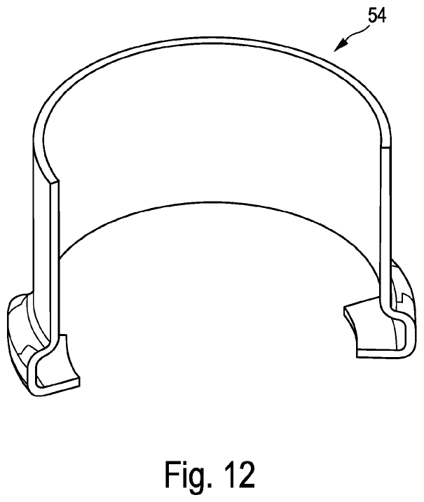

FIG. 12 shows the winding from FIG. 11,

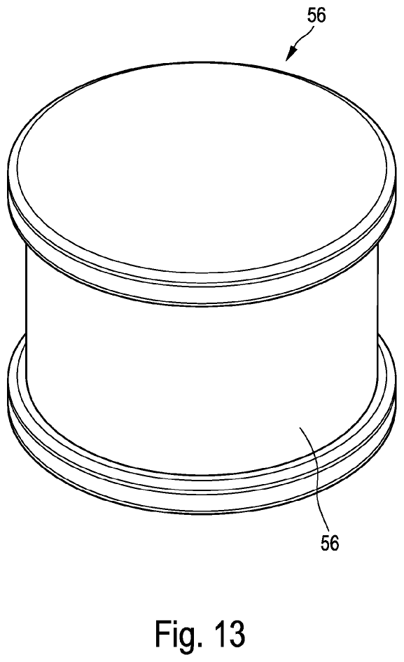

FIG. 13 shows the core from FIG. 11,

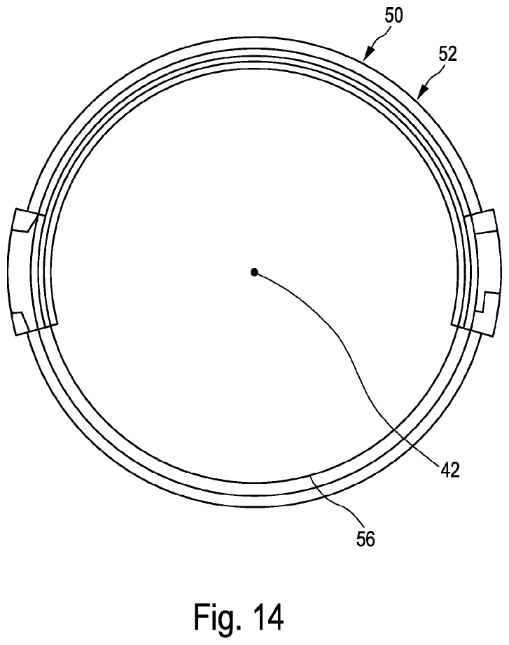

FIG. 14 shows a view of the coil from FIG. 11 from below,

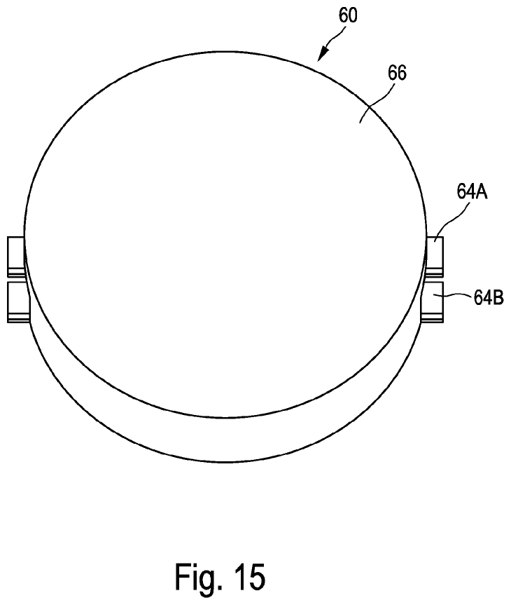

FIG. 15 shows a coil according to the invention according to a third embodiment obliquely from above,

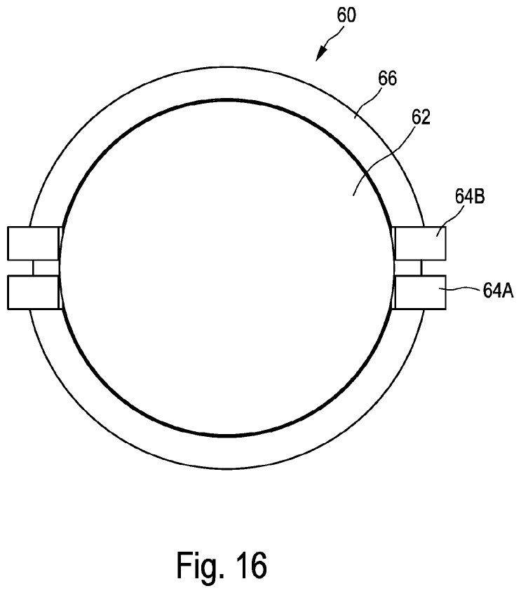

FIG. 16 shows the coil from FIG. 15 from below,

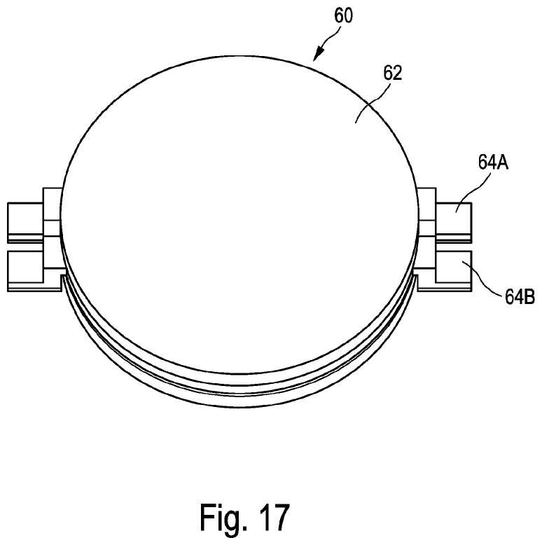

FIG. 17 shows the core and the windings of the coil from FIG. 15 obliquely from above,

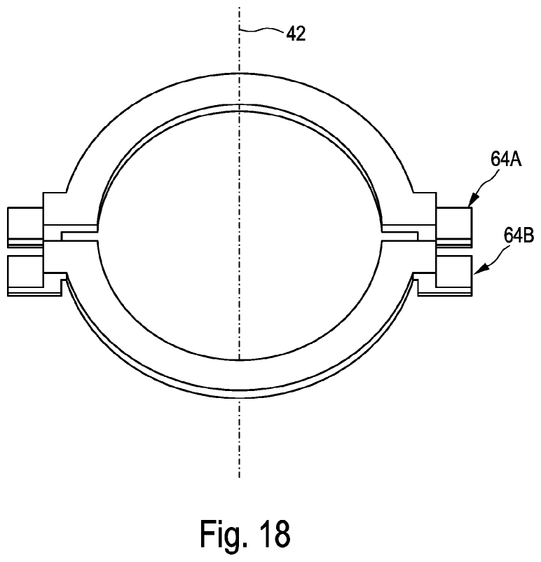

FIG. 18 shows the windings from FIG. 17,

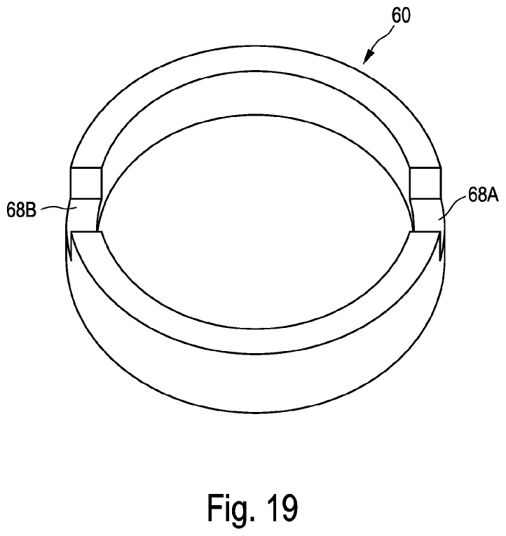

FIG. 19 shows the shielding ring of the coil from FIG. 15 obliquely from below,

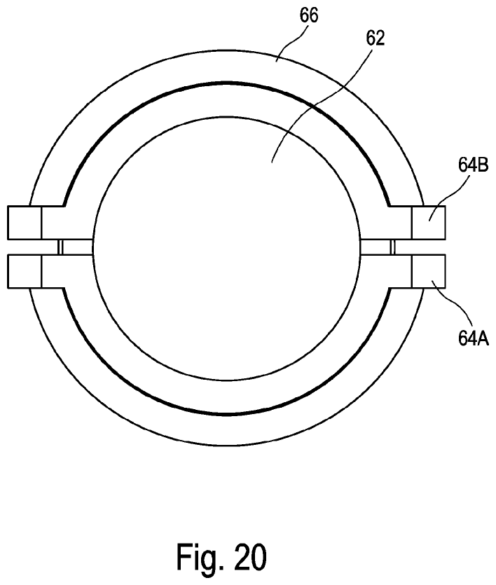

FIG. 20 shows a sectional view of the coil in the view of FIG. 15 without the core,

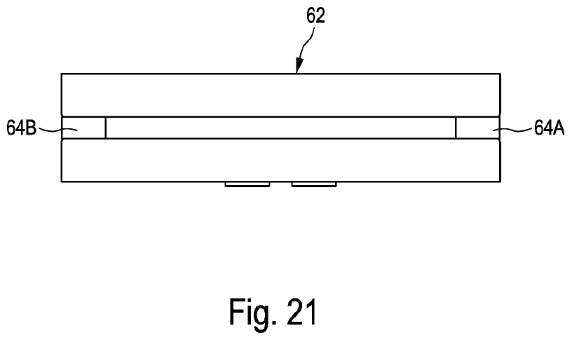

FIG. 21 shows a sectional view of the coil from FIG. 15 without the shielding ring,

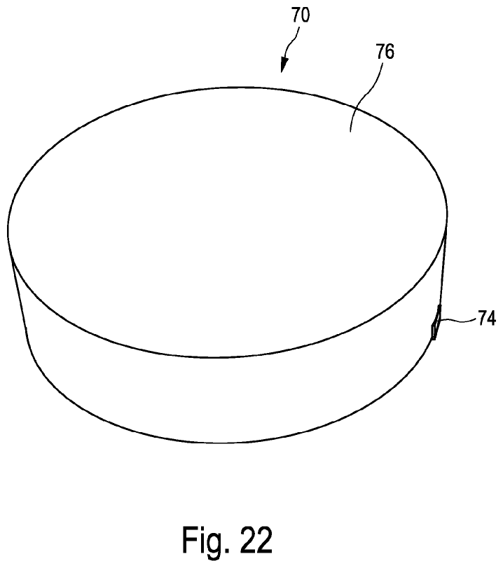

FIG. 22 shows a coil according to the invention according to a fourth embodiment obliquely from above,

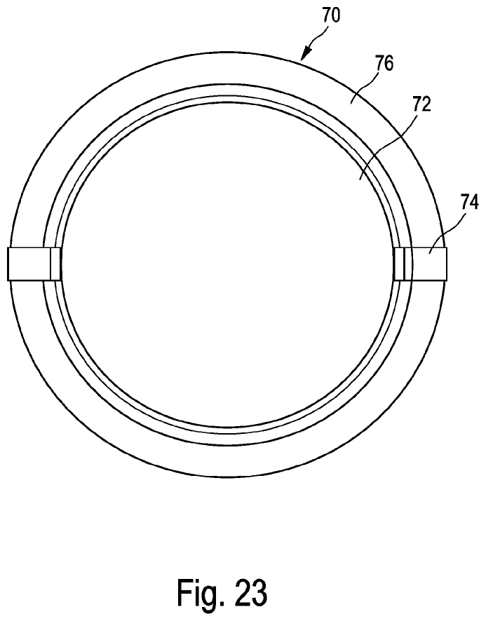

FIG. 23 shows the coil from FIG. 22 from below,

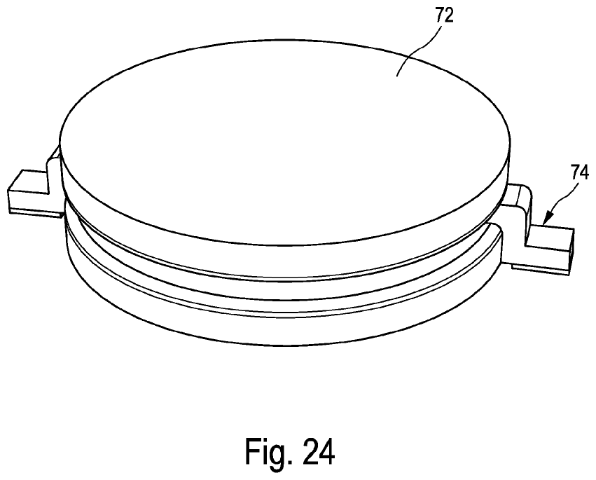

FIG. 24 shows the coil from FIG. 22 without the shielding component,

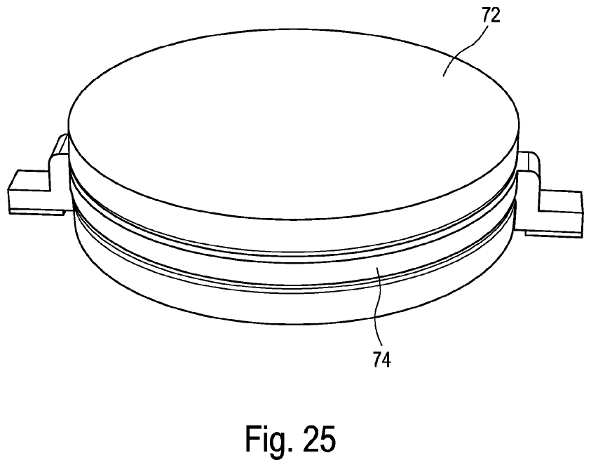

FIG. 25 shows the coil from FIG. 22 without the shielding component in a view rotated by about 180° with respect to FIG. 24,

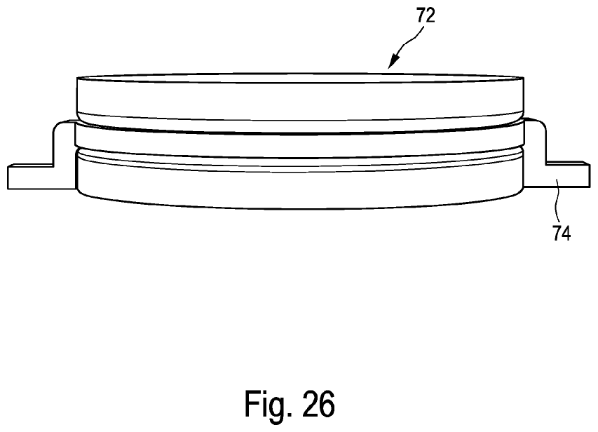

FIG. 26 shows the coil from FIG. 22 without the shielding component in a view from the side,

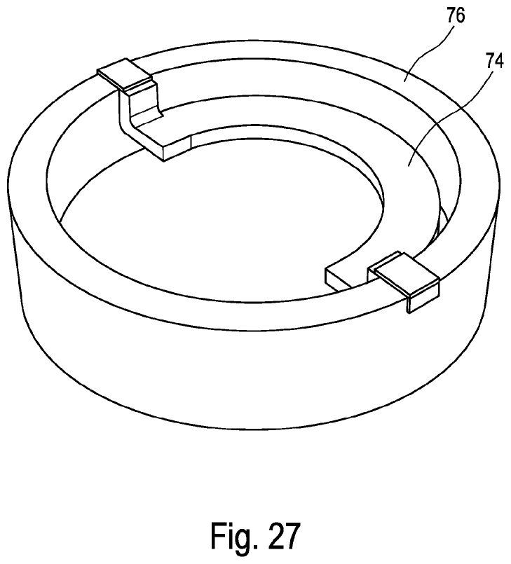

FIG. 27 shows the coil from FIG. 22 obliquely from below, the core being hidden,

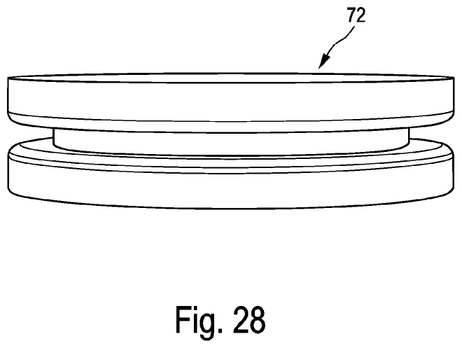

FIG. 28 shows the core of the coil from FIG. 22, and

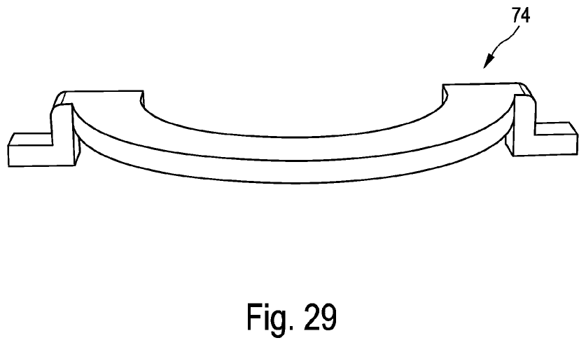

FIG. 29 shows the winding of the coil from FIG. 22,

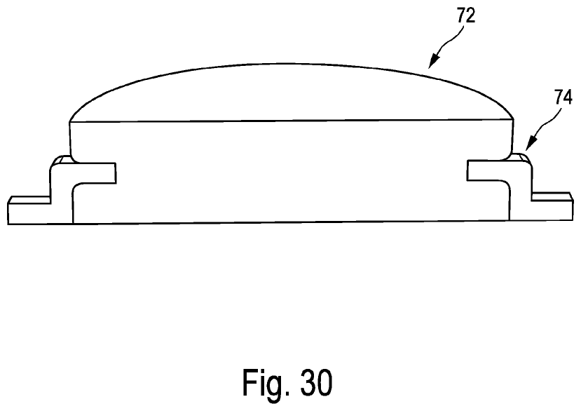

FIG. 30 shows a sectional view of the coil from FIG. 22 without the shielding component.

FIG. 1 illustrates a coil 10 according to a first embodiment of the invention. The coil 10 has a core 12 made of a soft magnetic material, for example ferrite, a winding which cannot be seen in FIG. 1, and a shielding component 16 formed as a shielding ring made of ferrite or an electrically nonconductive metal alloy.

FIG. 2 shows the coil 10 from FIG. 1 from below. In this view, two connection pads 18, 20 of a winding can be seen. The connection pads 18, 20 are arranged on the underside of the core 12, so that the coil 10 can be placed on connection areas of a circuit on a printed circuit board, and the connection pads 18, 20 can then be soldered to the connection areas on the printed circuit board. The coil 10 forms an SMD component (surface mounted device) as a result. The shielding ring 16 is square with a square outline. As a result, the shielding ring can be gripped without difficulty by means of a gripper or sucker.

FIG. 3 shows the core 12 and the winding 14, wherein the shielding ring has been hidden in the view of FIG. 3. The connection pads 18, 20 are for the most part concealed in the view of FIG. 3. Starting from the connection pad 18, a section 22 of the winding extends parallel to a central longitudinal axis of the core 12, therefore from bottom to top in FIG. 3, and is laid around a first circumferential protrusion 24 of the core. The core has a shape of a yarn bobbin having a central section 26, of which the lower end is formed by the circumferential protrusion 24 and of which the upper end is formed by a second circumferential protrusion 28. However, it can already be seen in FIG. 3 that the central section 26 consists of two sections with different diameters, wherein a respective step 30, 32 is formed at the transition of these two sections.

The winding 14 has a central winding section 34, which connects the sections 22, 36 of the winding 14 that are laid around the circumferential protrusion 24 to each other and which runs around the core 12 by somewhat more than 180°. The central winding section 34 extends between the circumferential protrusions 24, 28 of the core 12 and has a constant height which corresponds to the distance between the protrusions 24, 28 but can also be smaller within the scope of the invention.

It can be seen in FIG. 3 that, at the two ends of the central winding section 34 of the winding 14, in each case there is formed a protrusion 38 and 40 projecting inward, which engages on the steps 30 and 32.

The winding 14 is thus fixed to the core 12 as a result of the fact that the sections 22, 36 of the winding 14 engage around the protrusion 24, that the protrusions 38, 40 of the winding 14 engage on the steps 30, 32 of the core, and that the central winding section 34 is arranged between the protrusions 24, 28 of the core.

FIG. 4 shows a view of the core 12 obliquely from above, the winding and the shielding ring being hidden. In this view, the two steps 30, 32 can be seen easily, each extending parallel to the central longitudinal axis 42 of the core 12 between the first protrusion 24, the lower one in FIG. 4, and the second protrusion 28, the upper one in FIG. 4. The central section 26 of the core 12 is thus assembled from two sections, wherein both sections form part of circular cylinders with a different radius. A first section, at the front in FIG. 4, has a somewhat smaller diameter, and a second section, at the back in FIG. 4, has a somewhat larger diameter. The section with a somewhat larger diameter extends over somewhat more than 180° around the central longitudinal axis 42, for example 210°. The section with the somewhat smaller diameter extends by somewhat less than 180° around the central longitudinal axis 42, for example 150°. The two steps 30, 32 are formed between the section with the larger diameter and the section with the smaller diameter. The steps 32 extend radially relative to the central longitudinal axis 42. The steps 32 can also form a slight undercut, in order to allow the protrusions 38, 40 of the winding 14 to hook in.

FIG. 5 shows the winding 14 in a view obliquely from above. The winding and in particular the central winding section 34 extends over an angle of somewhat more than 180° around the central longitudinal axis 42, for example 210°. The winding 14 is produced from copper sheet. As a result, a very low DC resistance and also a low AC impedance can be achieved. Since the winding 14 extends only about an angle of somewhat more than 180° around the core 12, very low inductance values of less than 1 μH can be achieved with the coil 10 according to the invention from FIG. 1. The coil 10 illustrated in FIG. 1 with the winding 14 illustrated in FIG. 5 achieves an inductance value of about 80 nH to 130 nH. Within the scope of the invention, the inductance of the coil can also be less than 1 nH or else more than 1 μH. By means of a suitable selection of the material of the core 12, a very high saturation current can also be achieved.

In FIG. 5 it is possible to see the connection pads 18, 20 and then also the sections 22, 36 of the winding 14 that lead around the protrusion 24 on the core.

Likewise to be seen in FIG. 5 are the protrusions 38, 40 of the winding, which project in the direction of the central longitudinal axis 42 and which are arranged at the ends of the central winding section 34. The protrusions 38, 40 form first latching elements on the winding 14, and the steps 30, 32 on the core 12 form second latching elements on the core 12.

In order to mount the coil 10, the winding 14 is pushed onto the core 12 at right angles to the central longitudinal axis 42, so that the central winding section 34 of the winding 14 comes to lie between the two circumferential protrusions 24, 28. The winding 14 will be bent up somewhat, since the protrusions 38, 40 then slide along on the outer circumference of the core in the section with the larger diameter. In the illustration of FIG. 4, the winding 14 therefore would be pushed onto the core 12 from the rear. The winding 14 is pushed onto the core 12 until the protrusions 38, 40 on the winding 14 snap behind the steps 30, 32. Thereby, the winding 14 springs back and is then held reliably on the core 12 in a form-fitting manner.

The winding 14 can additionally also be fixed to the core 12 by the sections 22, 36 and the connection pads 18, 20 being pressed against the protrusion 24 of the core 12. This produces a still more reliable fixing of the winding 14 to the core 12 as a result.

FIG. 6 shows a view of the coil 10 from FIG. 1 from below, the core 12 having been hidden. It can be seen in this view that the central winding section 34 of the winding 14 is arranged at a uniform distance from an inner circumference of a passage opening of the shielding ring 16. On the other hand, the sections 22, 36 of the winding 14 rest partly on the inner circumference of the passage opening in the shielding ring 16. After the shielding ring 16 has been pushed on, the winding 14 is thus additionally secured on the core 12.

FIG. 7 shows a sectional view of the core 12 with the winding 14 arranged thereon. The section plane extends at right angles to the central longitudinal axis 42, cf. FIG. 4 and FIG. 5. In this sectional view, it is easy to see how the protrusion 38 of the winding 14 engages on the step 30 of the core 12 and how the protrusion 40 of the coil 14 engages on the step 32 of the core 12. It can also be seen in FIG. 7 that the central winding section 34 of the winding 14 extends over somewhat more than 180°, specifically 210°, around the circumference of the core 12.

Obviously, however, within the scope of the invention it is also possible to form the winding 14 such that it extends by an angle of less than 180°, for example 160°, around the circumference of the core 12. Within the scope of the invention, the winding 14 can extend by an angle of a maximum of 290° around the core 12.

FIG. 8 shows the sectioned core from FIG. 7 without the winding 14. In this view, the steps 30, 32 on the core 12 are clearly visible.

FIG. 9 shows the sectioned winding from FIG. 7 without the core 12. In this view, the protrusions 38, 40 of the winding 14 can clearly be seen.

FIG. 10 shows a further sectional view of the core 12 and the winding 14 arranged on the core 12, the section plane in FIG. 10 extending parallel to the central longitudinal axis 42 and including the central longitudinal axis 42. In this view, it can be seen how the sections 22, 36 of the winding 14 partly enclose the circumferential protrusion 24 on the core 12 and also fix the winding 14 to the core 12 as a result. It can also be seen that the connection pads 18, 20 rest on the underside of the core 12.

FIG. 11 shows a coil according to the invention according to a third embodiment. The coil 50 has a core 52 with a winding 54 arranged thereon. A shielding component is not illustrated in FIG. 11, since it can either be omitted but in any case would be designed identically to the coil 10 explained by using FIGS. 1 to The core 52 differs only slightly from the core 12, so that only the features that are different from the core 12 are described. The central section 56 of the core 52 is circularly cylindrical with a constant radius and has no steps.

The winding 54 is very similar to the winding 14, so that only the differences will be described. The winding 54 has no protrusions which extend in the direction of the core 52 but is otherwise the same as the winding 14.

The winding 54 will consequently be held on the core 52 by the sections 22, 36, which extend in the direction of the connection pads 18 and 20 and which are placed around the lower circumferential protrusion 24 of the core 52. The central winding section of the winding 14 rests flat on the central section 56 of the core 52. Furthermore, the winding 54 is held on the core 52 as a result of the fact that the central winding section of the winding 54 extends over somewhat more than 180°, especially 210°, about the central section 56 of the core 52, and that a height of the central winding section corresponds to a distance between the protrusions 24, 28 on the core 52.

In FIG. 12 only the winding 54 is illustrated. Since the central section of the winding 54 extends by somewhat more than 180°, especially 210°, around the central longitudinal axis, the winding 54 can be pushed sideways onto the core 56, is bent up slightly in the process and then springs back or is bent back, so that the winding 54 is then held automatically on the circularly cylindrical central section 56 of the core.

FIG. 13 shows the core 56 which, as has been explained, has a circularly cylindrical central section 56 but is otherwise the same as the core 12 of the coil 10.

FIG. 14 shows a sectional view of the coil 50 from above, the section plane extending at right angles to the central longitudinal axis 42. It can be seen that the central winding section of the winding 54 nestles against the central section 56 of the core 52 over an angle of somewhat more than 180°, especially 210°, and, as a result, is held on the central section 56.

FIG. 15 shows a coil 60 according to the invention according to a third embodiment. The coil 60 has a core, which cannot be seen in FIG. 15, a shielding component 66 and two windings 64A, 64B, which each extend around the core by somewhat less than 180°.

FIG. 16 shows the coil 60 in a view from below. The shielding component 66 is pot-shaped, and its circumferential wall surrounds the core 62 annularly. Each of the two windings 64A, 64B has a first winding connection and a second winding connection, wherein the winding connections each project radially from the core 62.

FIG. 17 shows the coil 60 from FIG. 15 without the shielding ring. It can be seen that the core 62 is shaped circularly cylindrically but has a circumferential groove in its circumferential surface. The windings 64A, 64B are inserted into this circumferential groove. The windings 64A, 64B are each produced from wire with a rectangular cross section.

FIG. 18 shows the windings 64A, 64B. The two windings 64A, 64B are formed mirror-symmetrically relative to each other. Each of the windings 64A, 64B has a central winding section in the form of a section of a circular ring. As has been explained, each central winding section extends over an angle of somewhat less than 180° around the core and the central longitudinal axis 42.

FIG. 19 shows the pot-like shielding component 66 obliquely from below. A circumferential wall of the shielding component 60 has two mutually opposite recesses 68A, 68B, which, in the mounted state, accommodate sections of the windings 64A, 64B, which then lead to the connection pads of the windings 64A, 64B.

FIG. 20 shows a sectional view of the coil 60, the section plane being arranged at right angles to the central longitudinal axis 42. The section plane extends through the circumferential groove in the core 62. It can be seen in FIG. 20 that the windings 64A, 64B rest with their respective inner circumference on a base of the groove in the core 62. An outer circumference of the windings 64A, 64B ends flush with an outer circumference of the core 62 and is located at a very short distance opposite an inner circumference of the shielding component 66.

The windings 64A, 64B are held in the groove of the core 62 as a result of the fact that, firstly, the rectangular cross section of the windings 64A, 64B is matched to the cross section of the groove, so that the windings 64A, 64B can, for example, be pressed easily into the groove. Secondly, however, the windings 64A, 64B are also held in the groove as a result of the fact that the shielding component 66 prevents the windings 64A, 64B from moving out of the groove in the radial direction.

FIG. 21 shows a sectional view of the core 62 with the two windings 64A, 64B. A section plane encloses the central longitudinal axis of the core 62. It can be seen that an outer circumference of the windings 64A, 64B ends with an outer circumference of the core 62.

FIG. 22 shows a view of a coil 70 according to the invention according to a fourth embodiment of the invention. In FIG. 22, it is possible to see substantially only one shielding component 76, which is pot-shaped and very similar to the shielding component 66 of the coil 60. FIG. 22 only partly reveals one winding end of a winding 74.

FIG. 23 shows the coil 70 from FIG. 22 from. below. In this view, it is possible to see the mutually opposite winding ends of the winding 74, which extends by slightly more than 180°, especially about 190°, around a core 72.

FIG. 24 shows the core 72 with the winding 74 arranged on the core obliquely from above. A central winding section of the winding 74 is arranged in a circumferential groove of the core 72. The core is circularly cylindrical but has a circumferential groove.

FIG. 25 shows the core 72 and the winding 74, the view having been rotated by about 180° as compared with FIG. 24. In the view of FIG. 25, it is possible to see the central winding section of the winding 74, which is arranged in the circumferential groove of the core 72 and of which the outer circumference ends flush with the outer circumference of the core 72.

FIG. 26 shows a view of the core 72 and the winding 74 from the side. The winding 74 is produced from wire with a rectangular cross section. A transition from the outer circumference of the core 72 into the groove is respectively rounded. As a result, the winding 74 can be pushed very easily and, for example, by a machine, into the groove in the core 72.

FIG. 27 shows the pot-shaped shielding component 76 and the winding 74 obliquely from below, without the core 72. The winding ends of the winding 74 are embedded in matching recesses in the circumferential wall of the shielding component 76. As a result, the connection pads, which are formed on the winding ends of the winding 74, project only slightly beyond the upper edge in FIG. 27 of the shielding component 76. By using these connection pads, the coil 70 can then be soldered to connection areas of a circuit on a printed circuit board. The upper edge of the shielding component 26 in FIG. 27 is arranged only very slightly above the printed circuit board as a result and can expediently also be supported on the printed circuit board. As a result, a mechanical connection of the coil 70 to the printed circuit board which, for example, is very stable with respect to vibrations, can be implemented.

FIG. 28 shows the core 72 without the winding 74. It can be seen that the circumferential groove has a rectangular cross section and that, as has been explained, the transitions from the outer circumference of the core 72 into the groove are each rounded, in order to make it easier to insert or push in the winding 74. For example, the winding 74 can be pressed into the groove, in order also to be anchored mechanically on the core 72 as a result.

Of course, within the scope of the invention, the winding 74 can also be adhesively bonded into the groove of the core 72.

FIG. 29 shows the winding 74 without the core 72.

FIG. 30 shows a sectional view of the core 72 with the winding 74 inserted into the groove of the core 72. It can be seen that the central winding section of the winding 74 extends as far as the base of the groove in the core 72. Starting from the central section, sections bent over at right angles relative to the central winding section are provided, which are then followed by the winding ends, which are in turn bent over at right angles and the undersides of which then form the connection pads.

1. A coil having an electrically conductive winding, wherein the winding has a first winding connection and a second winding connection, and having a magnetic core, wherein the winding extends up to a maximum angle of 290°, in particular 270°, around the core and the winding is fixed to the core.

2. A coil according to claim 1, wherein the winding extends at least by an angle of 160°, in particular 180°, around the core.

3. A coil according to claim 1, wherein two windings are provided, further wherein each winding has a first winding connection and a second winding connection, and in that each winding extends around the core at least by an angle of 160° and at most by an angle of 290°.

4. A coil according to claim 1, wherein the winding is at least partly formed of metal sheet or of a metal wire with a square or rectangular cross section.

5. A coil according to claim 1, wherein the winding has at least one first latching element and the core has at least one second latching element, wherein, in the mounted state of the winding on the core, the at least one latching element of the winding interacts with the at least one second latching element of the core in order to hold the winding on the core.

6. A coil according to claim 5, wherein the at least one first latching element is formed as a protrusion on the winding which projects in the direction of the core, and the at least one second latching element on the core is formed as a recess or step in the core, wherein the recess or step in the core is designed to match the protrusion on the winding.

7. A coil according to claim 1, wherein a shielding component made of ferrite or an electrically nonconductive metal alloy is provided, which at least partly surrounds the core and the winding.

8. A coil according to claim 7, wherein the shielding component is bonded to the core by means of adhesive.

9. A coil according to claim 8, wherein the adhesive has ferrite particles or particles of an electrically non-conductive metal alloy.

10. A coil according to claim 1, wherein the core is provided with a groove running around the core by at least 160°, wherein the winding is partially inserted into the groove.

11. A coil according to claim 10, wherein the winding is latched into the groove, pressed into the groove and/or bonded into the groove.

12. A coil according to claim 1, wherein the core is provided with at least one circumferential protrusion, the winding engaging partially around the protrusion.

13. A coil according to claim 12, wherein a section of the winding is pressed onto the protrusion.

14. A method for producing a coil according to claim 1, comprising the steps of arranging the at least one winding on the core and of fixing the winding to the core.

15. A method according to claim 14, wherein the winding in the mounted state, extends by more than 180° and a maximum of 290° around the core, further including the steps of bending the winding up, of pushing the winding onto the core and of bending back or springing back the winding, so that the winding partly surrounds the circumference of the core.

16. A method according to claim 14, wherein the winding has at least one first latching element and the core has at least one second latching element, further including pushing the winding onto the core and latching the first latching element into the second latching element.

17. A method according to claim 14, further including bonding the winding and the core.

18. A method according to claim 14, further including pushing a shielding component onto the core, wherein the winding is arranged at least partly between the shielding component and the core.

19. A method according to claim 18, further including bonding the shielding component to the core and/or the winding.

20. A method according to claim 14, wherein the core has at least one circumferential protrusion, further including pressing at least one section of the winding onto the protrusion.

21. A method according to claim 20, further including pressing a first section and a second section of the winding onto the protrusion, wherein the first section and the second section extend parallel to a central longitudinal axis of the core.

22. A method according to claim 14, further including rolling the winding from copper.

23. A method according to claim 14, further including punching the winding from copper sheet.

24. An arrangement having a printed circuit board and a coil according to claim 1, wherein the first winding connection and the second winding connection are formed as connection pads and are soldered to connection areas of a printed circuit board.
